(19) United States
(12) Patent Application Publication
(10) Pub. No.: US 2015/0106120 A1
(43) Pub. Date: Apr. 16, 2015

(54) COMPUTER SYSTEM AND COMPUTER IMPLEMENTED METHOD FOR GENERATING A CLINICIAN WORK-LIST FOR TREATING A PATIENT

(71) Applicants: Lucky Kirk Sahualla, Houston, TX (US); Randal Charles Bartosh, Village of Tiki Island, TX (US)

(72) Inventors: Lucky Kirk Sahualla, Houston, TX (US); Randal Charles Bartosh, Village of Tiki Island, TX (US)

(21) Appl. No.: 14/511,887

(22) Filed: Oct. 10, 2014

Related U.S. Application Data
(60) Provisional application No. 61/889,237, filed on Oct. 10, 2013.

(51) Int. Cl. G06F 19/00

(52) U.S. Cl. CPC G06F 19/345; G06F 19/3431; G06F 19/327
USPC 705/3

(57) ABSTRACT

A computer system may implement a method on a non-transitory computer readable medium for generating at least one clinician work-list for treating a patient. The computer-implemented method may include maintaining at least one patient profile for at least one patient where the patient profile includes patient details and at least one scorable factor associated with the patient. The scorable factor(s) may be selected from at least one client device and scored according to an initial ability of the patient. At least one goal may be created where the created goal(s) has a scoring in relation to each scored factor. The created goal(s) may be assigned to at least one clinician shift as at least one task. At least one clinician work-list may be generated that is associated with the clinician shift where the clinician work-list comprises the task(s).

### CROSS-REFERENCE TO RELATED APPLICATION

This application claims the benefit of Provisional Patent Application No. 61/889,237 filed Dec. 10, 2013, which is incorporated by reference herein in its entirety.

### TECHNICAL FIELD

The present invention relates to a computer implemented method on a non-transitory computer readable medium for generating at least one clinician work-list for treating a patient where the clinician work-list has a task assigned thereto related to an initial ability of a patient.

### BACKGROUND

The health care system includes a variety of participants, such as clinicians, hospitals or facilities, insurance carriers, and patients. A plethora of health care information storage and retrieval systems are also necessary to support a heavy flow of information related to patient care. All participants in the health care system frequently rely on each other for the information necessary to perform their respective roles because individual care is delivered and paid for in numerous locations by individuals and organizations that are typically unrelated. As a result, critical patient data is stored across many different locations using incompatible legacy mainframe and client-server systems that store information in non-standardized formats.

To ensure proper patient diagnosis and treatment, health care providers must often request patient information by phone or fax from hospitals, laboratories, or other providers, and even from other participants in their own treatment setting. Such assessment and treatment information is recorded and stored in separate systems, i.e. whatever system the healthcare provider may use. Therefore, disparate systems and information delivery procedures maintained by a number of independent health care system constituents lead to gaps in timely delivery of complete patient records and may compromise the overall quality of clinical care. This is even the case for a patient whose records are present in one facility; each clinician has a separate file for the patient, and it is very difficult for each clinician to facilitate a cohesive plan with other clinicians within a single facility with regards to a single patient. Typically, each clinician cannot view a treatment plan from another clinician, so each clinician forms a treatment plan independent of treatment plans formed by other clinicians.

Since a typical health care practice is concentrated within a given specialty, an average patient may be using services of a number of different specialists, each potentially having only a partial view of the patient's medical status, and each being able to provide only a partial view of the patient's medical status. To obtain an overview or establish a trend of his or her medical data, a patient (and the patient's primary care physician) is forced to request the medical records separately from each individual health care provider and attempt to reconcile the piecemeal data. Potential gaps in complete medical records further reduce the value of medical advice given to the patient by each health care provider. Existing solutions have generally addressed the problem of centralized storage of health care information, but do little more than store that information and make it available in a presentable form. In particular, these existing solutions do not incorporate analysis of a patient's health care information in order to find medical issues that may require attention.

Thus, a need still exists for a personal health record system capable of clinically analyzing the accumulated relevant health care information in light of appropriate clinical standards to arrive at a comprehensive understanding of the patient's prognosis.

### SUMMARY

There is provided, in one form, a computer implemented method on a non-transitory computer readable medium for generating at least one clinician work-list for treating a patient. The computer-implemented method includes maintaining at least one patient profile for at least one patient where the patient profile includes patient details and at least one scorable factor associated with the patient. The scorable factor(s) may be selected from at least one client device and scored according to an initial ability of the patient. At least one goal may be created where the created goal(s) has a scoring in relation to each scored factor. The created goal(s) may be assigned to at least one clinician shift as at least one task. At least one clinician work-list may be generated that is associated with the clinician shift where the clinician work-list comprises the task(s).

There is further provided in an alternative embodiment, a computer system having a host server with a processor, a network in communication with the host server, and at least one client device in communication with the network. The client device may include at least one user interface, an input device, and a display device. ‘User interface’ is the portion of the client device where a user may interact with the client device to effectively operate the computer-implemented system therefrom. The ‘input device’ is the portion of the client device, which may receive information or input from a user when the user interacts with the user interface of the client device. A ‘display device’ is the portion of the client device that allows the user to view information thereon; a non-limiting example of a display device is the screen of a computer monitor, the screen of a smart phone or tablet, and the like.

A data storage may be in communication with the server, and the data storage may include at least one patient profile, at least one scored factor, at least one goal associated to the each scored factor, at least one task assigned to at least one clinician shift where the task(s) relates to the goal(s), and a plurality of computer instructions. The computer instructions may be for maintaining the patient profile(s) for the patient(s) where each patient profile comprises patient details associated with the patient(s); computer instructions for receiving a selection of at least one scorable factor associated with the patient profile(s) from at least one client device; computer instructions for receiving at least one scored factor(s) according to an initial ability of the patient from the client device(s); computer instructions for creating at least one goal where the created goal(s) have a scoring in relation to the scored factor(s); computer instructions for assigning the created goal(s) to at least one clinician shift as at least one task; and computer instructions for generating at least one clinician work-list associated with the clinician shift(s) where the clinician work-list comprises the task(s).

There is further provided in another alternative non-limiting embodiment of the computer system previously described where the computer system also includes a companies module and a users module. The companies module may include at least one company profile, and computer instructions for maintaining the company profile(s) where the company profile(s) comprise at least one company detail for each company. The users module may include at least one user profile, at least one user privilege, at least one user location, and computer instructions. The computer instructions may be or include, but are not limited to computer instructions for maintaining the user profile(s) where each user profile has at least one user detail for at least one user; computer instructions for receiving a user selection from a client device; computer instructions for receiving a selected user privilege for a selected user profile; and computer instructions for receiving an assignment of at least one location for a selected user profile.

The computer implemented methods and computer systems appear to improve the ability of the clinician to treat a specific patient with a more systematic approach.

### BRIEF DESCRIPTION OF THE DRAWINGS

FIG. 1 is a non-limiting example of the architecture for generating at least one clinician work-list for treating a patient;

FIG. 2 is an illustration of a non-limiting embodiment of the clinician work-list module;

FIG. 3 is an illustration of a non-limiting embodiment of the companies module;

FIG. 4 is an illustration of a non-limiting embodiment of the users module;

FIG. 5 is an illustration of a non-limiting embodiment of the reports module;

FIG. 6 is an illustration of a non-limiting embodiment of the manage locations module;

FIG. 7 is an illustration of a non-limiting embodiment of the client device;

FIG. 8 is a screenshot of a home screen having selectable modules;

FIG. 9 is a screenshot of a patient selection screen;

FIG. 10 is a screenshot of a factors screen for a selected patient;

FIG. 11 is a screenshot of the factors screen where the factors have been scored;

FIG. 12 is a screenshot of a goals screen where a goal may be created in relation to each scored factor;

FIG. 13 is a screenshot of a factors screen different from that illustrated in FIG. 10;

FIG. 14 is a screenshot of a goals screen different from that illustrated in FIG. 13;

FIG. 15 is a screenshot of another type of factors screen;

FIG. 16 is a screenshot of an alternative embodiment of scoring the factors;

FIG. 17 is a screenshot of a non-limiting example where a scorable factor may be manually inserted by a clinician;

FIG. 18 is a screenshot of an assignment screen;

FIG. 19 is screenshot of a clinician work-list screen; and

FIG. 20 is a screenshot of scoring a task upon completion of the task by the clinician.

### DETAILED DESCRIPTION

It has been discovered that a computer implemented method and/or a computer-implemented system may assist clinicians in better treatment of their patients by generating a clinician work-list specific to each patient. By maintaining this patient information in a computer system, such treatments may be better monitored and tracked. The computer-implemented method and computer system may allow a clinician to identify and score factors specific to the patient, set goals related to the factors, organize a treatment plan and track the progress of such treatment, perform a follow-up assessment if needed, report results, etc. A user (e.g. a hospital administrator who may or may not also be a clinician) or clinician may easily obtain a patient status or previous treatment. A clinician is defined herein as anyone who may perform a clinical treatment to a patient. The computer-implemented method also provides a streamlined approach to assessing a patient for treatment, while allowing for reports to be generated therefrom for insurance purposes, statistical purposes, follow-up treatment purposes, etc. ‘Treatment’ or ‘clinical treatment’ are defined herein to be a treatment provided by any clinician, such as a nurse, physical therapist, occupational therapist, physician, etc.

A ‘treatment’ may be in the form of a skilled intervention. For example, an occupational therapist may analyze a patient's home and determine that the patient would function better with the placement of a handrail next to a toilet. Or a treatment might be a nurse educating a patient or family member on the use of a blood pressure cuff and establishing a daily log to monitor blood pressure. Another example of a treatment in the form of a skilled intervention may include a clinician working with family members (or hired help) to set up systems to aid the patient with daily tasks, such as having someone bring food to the patient, having someone wash the patient's laundry, having someone set up social services for the patient, and the like. These non-limiting examples of skilled interventions are considered ‘treatment’ for purposes described herein. ‘Patient’ is defined herein to be a person seeking treatment from a clinician.

The portability of the software and centralization of the information onto one server allows for streamlining of the patient's care. In addition, the continuity of care for the patient may be maintained, and the care may be consistent among all of the clinicians providing treatment to the patient. Having such a computer-implemented system also allows for more efficiency of patient care because two or more clinicians are not providing the same treatments to the patient; each clinician may be made aware of the types of treatments already performed by another clinician, or not performed in some instances. Said differently, the treatment history of the patient is easily accessible and viewable by any clinician at any given time, which also decreases the variability of care between caregivers.

Typically, each clinician has a set of treatments that the clinician may perform, which vary from other types of clinicians; e.g. nurses provide different treatments from physical therapists or occupational therapists. However, in a non-limiting embodiment, the patient may only have one clinician. So, this clinician may use the computer-implemented method to assess and assign any of the clinician tasks, regardless of whether the clinician is a physical therapist, and the additional tasks are nurse-related as an example.

The reports are key to substantiating the orders for, and the work done, under the orders by a clinician for purposes of billing a patient or the patient's insurance company (e.g. Medicare). Such reports support the orders from the physician, and the reports may provide a status of the patient during the course of treatment for the patient.

Moreover, home health clinicians typically aid the patient in improving at least one functional purpose. An insurance company may not reimburse a clinician for increasing the range of motion in a patient's shoulder, but the insurance company may reimburse the clinician to improve the patient's ability to dress himself, which is a non-limiting example of functional purpose. The ‘functional purpose’ is a purpose that helps the patient perform a task better by improving the functionality of a particular body part, as opposed to simply improving a body part for the sake of improving the body part, or by implementing strategies to compensate for diminished physical ability. The reports provide a metric to show improvement with these types of functional purposes.

These reports may be used for obtaining orders for care, for demonstrating implementation of treatment interventions consistent with the orders, and for billing insurance companies (e.g. Medicare), as well as reviewing statistical analysis. The statistics may allow for a comparison of whether a patient is able to accomplish all necessary tasks and functions with or without assistance from another person. Clinicians may also be compared based on metrics related to resolution of patient issues, number of treatments performed, and the like.

The reports may also be used to generate a status report for each patient, for each clinician, for each facility, etc. A particular patient may need several different clinicians to improve all necessary functional purposes, whether the clinicians are of the same type or different type, such as two nurses; one physical therapist; etc. For each functional purpose, the safety, independence, burden of care, quality of life, medical condition management, and combinations thereof are measured and determined by performing an assessment, analyzing/ranking factors, identifying tasks, making notes, scoring factors, and combinations thereof. Smaller tasks related to the functional purpose, of the desired improvement as a whole, may be divided among the clinicians responsible for the outcome of the patient. At any given time, the status of the patient with respect to the work done by each clinician, or the overall status (from all of the clinicians) of the patient may be viewed by generating a status report.

Alternatively, the overall status of many different patients may be viewed at once by selecting a facility, such as a hospital, nursing home, and the like. In another non-limiting embodiment, the status of several different clinicians may also be viewed. For example, the patient outcomes may be used to rate the ability of the clinicians after determining the patient outcome and/or the clinician's role on a team. Moreover, the status of several clinicians who attend to one patient may be viewed to further determine whether a particular clinician is participating within the team towards a desirable patient outcome.

In one embodiment, a computer-implemented method on a non-transitory computer readable medium may be used for generating at least one clinician work-list for treating a patient. The computer-implemented method includes maintaining at least one patient profile for at least one patient where the patient profile includes at least one patient detail and at least one scorable factor associated with the patient. Prior to performing the computer-implemented method, or alternatively during the computer implemented method, the computer system may receive patient detail(s) for each patient and create the patient profile with the patient detail(s).

The scorable factor(s) may be selected from at least one client device and scored according to an initial ability of the patient. In the non-limiting instance of two or more scorable factors, at least two scorable factors may be associated with at least one category on a clinician work-list. Alternatively, the clinician work-list may have at least two categories. ‘Initial ability’ or ‘initial assessment’ is defined as the ability assessed at the time of admitting the patient into the care of a clinician or facility (e.g. a hospital or nursing home) for the first time. ‘Client device’ is defined herein to be a device usable by a client for treatment of a patient. A ‘client’ may be any person who may aid in providing treatment to a patient, such as but not limited to, administrative personnel, a clinician, and the like.

At least one goal may be created where the created goal(s) has a scoring in relation to each scored factor. The created goal(s) may be assigned to at least one clinician shift as at least one task. At least one clinician work-list may be generated that is associated with the clinician shift where the clinician work-list comprises the task(s). In a non-limiting instance, at least one clinician work-list may be assigned to a date on a calendar.

In a non-limiting embodiment, the completed task may be scored by the clinician from a client device. In another non-limiting embodiment, an alert may be generated when the score of completed task(s) is greater than or equal to the scoring of the corresponding created goal(s).

In some non-limiting instances, the patient may need a follow-up evaluation either during a clinician shift by a clinician or after the patient has completed a particular task or tasks with the clinician, or both. The computer system may receive follow-up information associated with each patient profile, which may have or include at least one follow-up assessment of the patient. At least one follow-up factor may be selected from the client device, and each follow-up factor may be scored from the client device. The follow-up factor may be scored according to its corresponding follow-up ability of the patient. At least one follow-up goal may be created that is associated with the scored follow-up factor. The created follow-up goal(s) may have a scoring in relation to each scored follow-up factor. The created follow-up goal(s) may be assigned to at least one clinician shift as at least one follow-up task, and the clinician work-list may include the follow-up task(s). A ‘follow-up assessment’ is defined herein to mean any assessment performed after the initial assessment. Similarly, a ‘follow-up factor’ is defined herein to mean any factor that has already been scored a first time; i.e. the follow-up factor may be the same factor as the initial factor, but the follow-up factor has been scored at least a second time during a follow-up assessment of the particular follow-up factor.

The creation of the initial goal(s), follow-up goal(s), the assignment of the initial goal(s), the assignment of the follow-up goal(s), and/or the scoring of the completed initial task(s) or follow-up task(s) may occur from the client device. The client device may be or include, but is not limited to a tablet (e.g. an iPad manufactured by Apple Computers), a smart phone (e.g. a BlackBerry, iPhone, and the like), a computer, etc.

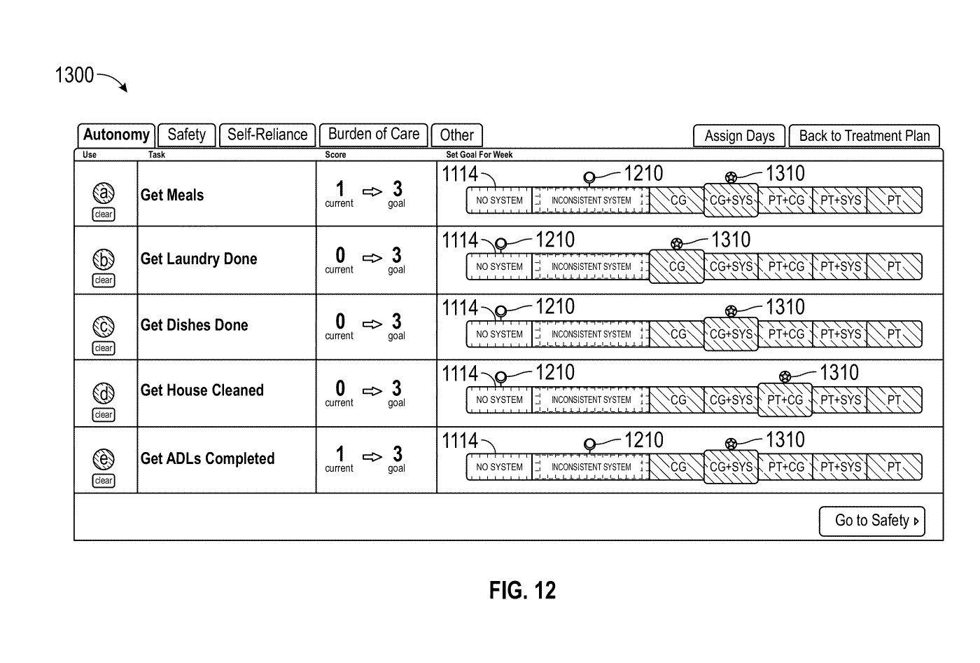

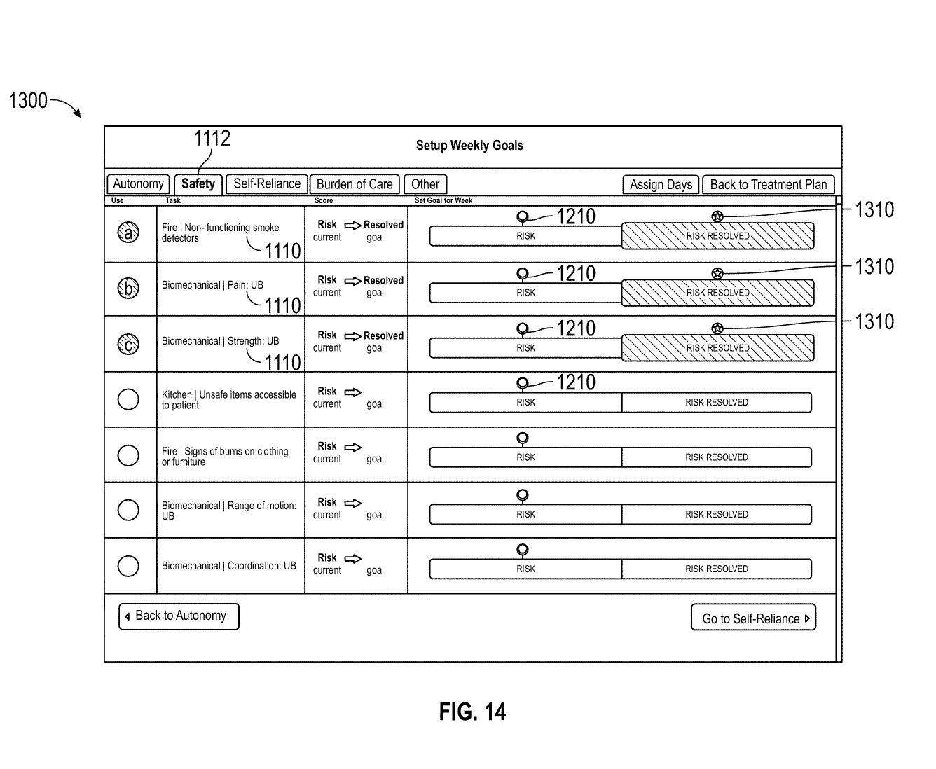

At any given time, at least one report for each patient may be generated where the report may have or include the scored factor(s), the created goal(s), the task(s), the scoring of the completed task(s), or combinations thereof. Other non-limiting examples of report(s) may be or include a SAFEST report, MedConCIRN, a patient outcomes profile (POP) report, an autonomy profile score (APS) report, a 700 form, and combinations thereof once at least one completed task has been scored. The SAFEST report compiles a score from the answers to the questions within the safety screen (see FIG. 14). A POP report is a compilation of scores related to the patient; the clinician selects the scores or information related to the patient each time a POP report is generated. Thus, two POP reports may be the same or similar depending on the selected scores to be viewed by the clinician. The APS report compiles a score from the answers to the scorable factors within the autonomy screen (see FIG. 12). A 700 form may be used to generate or view orders for a clinician related to the patient.

The MedConCIRN report is a score compiled from the answers to the MedConCIRN questions where the clinician answers a plurality of questions having a yes or no answer (not shown in the FIGS.). Such scorable factors for the MEDConCIRN report may be or include, but are not limited to ‘Monitor vitals and symptoms related to medical condition(s)’, ‘Vitals and symptoms stay within established parameters’, ‘Respond appropriately to changes in medical condition’, ‘Maintain a reconciled list of medicines, dosages, and schedules’, ‘Follow medication/treatment regimen’, ‘Obtain medications’, ‘Maintain compliance with precautions and restrictions’, ‘Understand disease process, signs, and symptoms’, and the like.

Each report may have a score related to the patient's current readiness for discharge, or may contribute to the projected date of discharge from a facility or from the care of a clinician. And each clinician caring for the patient contributes to the overall score. In a non-limiting example, the APS report may have 51 total points where a nurse's scoring of the patient contributes 9 points, an occupational therapist's scoring of the patient contributes 27 points, and a physical therapist's scoring of the patient contributes 15 points. When the clinician scores the patient for various items associated with the clinician tasks under the APS tab, the clinician's scoring of the specific clinician tasks (i.e. a nurse's set of items to be scored may be different from a physical therapist, a physician, etc.) contributes to the overall score for the APS report. Said differently, the overall score for a patient may be broken down into sub-scores for the patient, and it is these sub-scores that may determine or contribute to the clinician task list.

Prior to using the computer-implemented methods herein, each clinician could only determine the patient's overall status by obtaining the status from the other clinicians working with the patient. This required each discipline to work together for the benefit of the patient, which rarely happened. The computer-implemented methods may allow for better continuity of care for a patient because each clinician can easily view patient factors scored by other clinicians.

In another non-limiting example, a SAFEST score of less than 20 risks may mean a patient is at ‘low risk’ for an unsafe occurrence leading to a hospital readmission; a score of 20-40 risks means a patient is ‘at risk’ for an unsafe occurrence leading to a hospital readmission, and a score of 40 or above means a patient is at ‘high risk’ for an unsafe occurrence leading to a hospital readmission. Of the SAFEST risk factors, nursing may assess 12 factors, physical therapists may assess 50 factors, and occupational therapists may assess 80 factors. The APS report and the SAFEST report may include key scores to determine whether a patient is ready for discharge, or to determine a projected time when the patient may be ready for discharge if not currently ready.

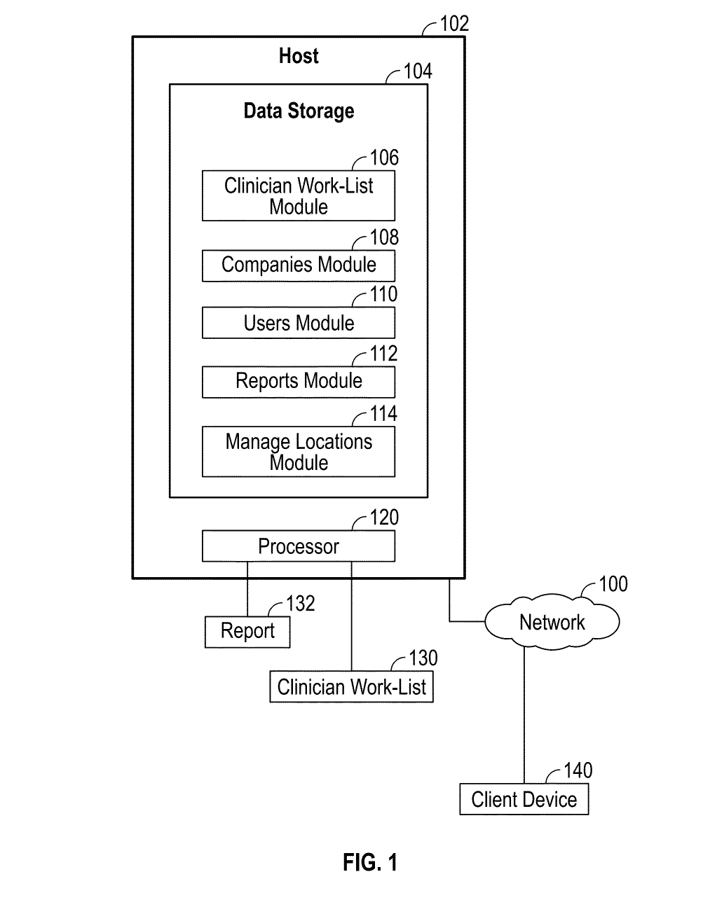

Now turning to the Figures, FIG. 1 is a non-limiting example of the architecture for generating at least one clinician work-list for treating a patient. There is a host 102 with a processor 120, a network 100 in communication with the host 102, and at least one client device 140 in communication with the network 100. The host 102 and/or the client device 140 may have a wired connection or wireless connection to the network 100. The host 102 may be a server stored locally (e.g. at a particular facility), or the host may be a server ‘in the cloud’, or another host source available to one skilled in the art. Each client device has or includes at least one user interface (not shown), an input device (not shown), and a display device (not shown). A data storage 104 is in communication with the host 102, and the data storage 104 may include a clinician work-list module 106, an optional companies module 108, an optional users module 110, an optional reports module 112, an optional manage locations module 114, or combinations thereof. The clinician work-list module may generate at least one clinician work-list 130 and/or a report 132; the reports module 112 may generate at least one report 132 that is the same report or different report generated from the clinician work-list module 106. “Module” is defined herein to be a set of components usable with the computer-implemented method.

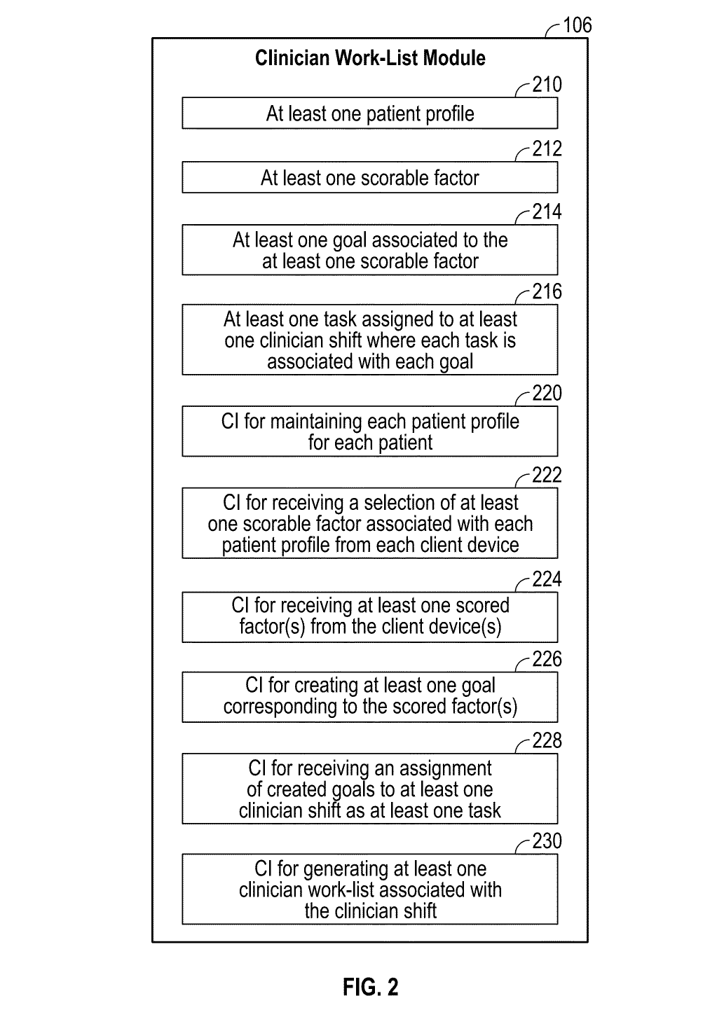

FIG. 2 is an illustration of a non-limiting embodiment of the clinician work-list module 106. The clinician work-list module 106 may have or include, but is not limited to at least one patient profile 210, at least one scorable factor 212 to be scored, at least one goal associated to the scorable factor 214, at least one task assigned to at least one clinician shift where each task is associated with each goal 216, a plurality of computer instructions associated with the clinician work-list module 220-230, or a combination thereof. The patient profile 210 may have at least one patient detail, such as but not limited to name, date of birth, symptoms, height, weight, other patient identifiers, and the like.

The plurality of computer instructions associated with the clinician work-list module may have or include, but is not limited to computer instructions for maintaining each patient profile for each patient 220, computer instructions for receiving a selection of at least one scorable factor associated with each patient profile from at least one client device 222, computer instructions for receiving at least one scored factor(s) from the client device(s) 224, computer instructions for creating at least one goal corresponding to the scored factor(s) 226, computer instructions for receiving an assignment of created goals to at least one clinician shift as at least one task 228, and computer instructions for generating at least one clinician work-list associated with the clinician shift(s) where the clinician work-list comprises the task(s) 230.

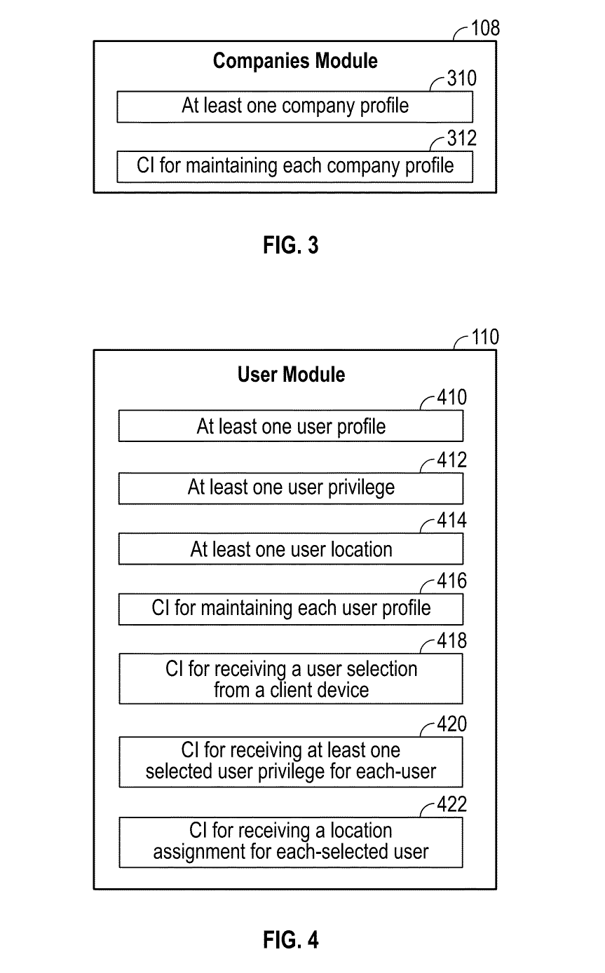

FIG. 3 is an illustration of a non-limiting embodiment of the companies module 108. The companies module 108 may have or include, but is not limited to, at least one company profile 310, and computer instructions for maintaining each company profile 312. Each company profile 310 may have at least one company detail for each company, such as but not limited to name of the company, address of the company, clinicians assigned to a particular company, etc.

FIG. 4 is an illustration of a non-limiting embodiment of the users module 110. The users module 110 may have or include, but is not limited to at least one user profile 410, at least one user privilege 412, at least one user location 414, users module computer instructions 416-420, or combinations thereof. Each user profile 410 may have at least one user detail for each user. A user privilege 412 may define the scope of the user's ability in relation to the computer system. For example, a nurse may have a particular set of user privileges that differ from a set of user privileges associated with a hospital administrator. The users location 414 may be one or more locations to which the user is assigned to allow the user to access patient or user information relevant to that location.

The users module computer instructions may be or include, but are not limited to, computer instructions for maintaining each user profile 416; computer instructions for receiving a user selection from a client device 418; computer instructions for receiving at least one selected user privilege for each user from a client device 420; and computer instructions for receiving a location assignment for each selected user 422.

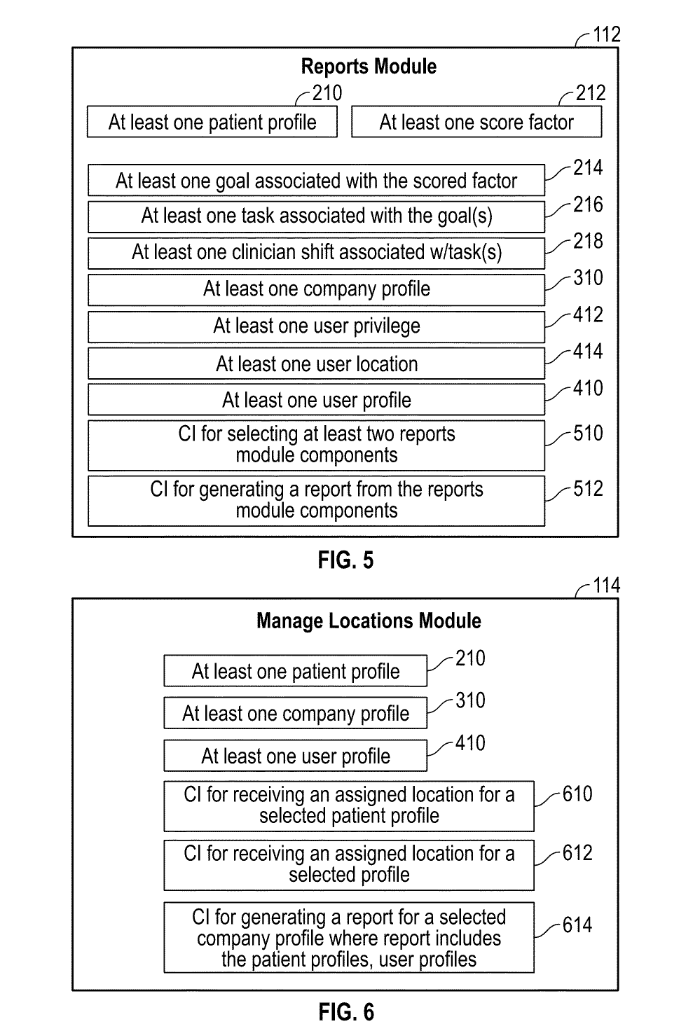

FIG. 5 is an illustration of a non-limiting embodiment of the reports module 112. The reports module may access information from the other modules to generate customizable reports, such as reports related to a specific group of patients, reports related to a particular location where patients reside (e.g. a nursing home facility), reports related to a particular clinician(s), reports related to a selected date or dates, or combinations thereof.

The reports module 112 may have or include, but is not limited to, at least one patient profile 210, at least one scorable factor 212, at least one goal associated with the at least one scored factor 214, at least one task associated with the at least one goal 216, at least one clinician shift associated with the at least one task 218, at least one company profile 310, at least one user privilege 412, at least one user location 414, at least one user profile 410, computer instructions 510-512, and combinations thereof.

The reports module 112 computer instructions may be or include, but are not limited to, computer instructions for selecting at least two reports module components 510, computer instructions for generating a report from the selected reports module components 512, and combinations thereof.

FIG. 6 is an illustration of a non-limiting embodiment of the manage locations module 114. The manage locations module may relate to a specific location of patients for which a specific group of clinicians perform assessments and/or care for such patients. The clinician may be assigned one location or several locations. By selecting a specific location within the manage locations module 114, all patients and all clinicians may be listed; in addition, specific patients and/or clinicians of a specific location may be selected for further viewing of statistics and/or reports.

The manage locations module 114 may have or include, but is not limited to, at least one patient profile 210, at least one company profile 310, at least one user profile 410, computer instructions 610-614, and combinations thereof. The manage locations module computer instructions may be or include, but is not limited to, computer instructions for receiving an assigned location for a selected patient profile 610, computer instructions for receiving an assigned location for a selected user profile 612, computer instructions for generating a report for a selected company profile where the report includes the patient profiles, the user profiles, or both 614.

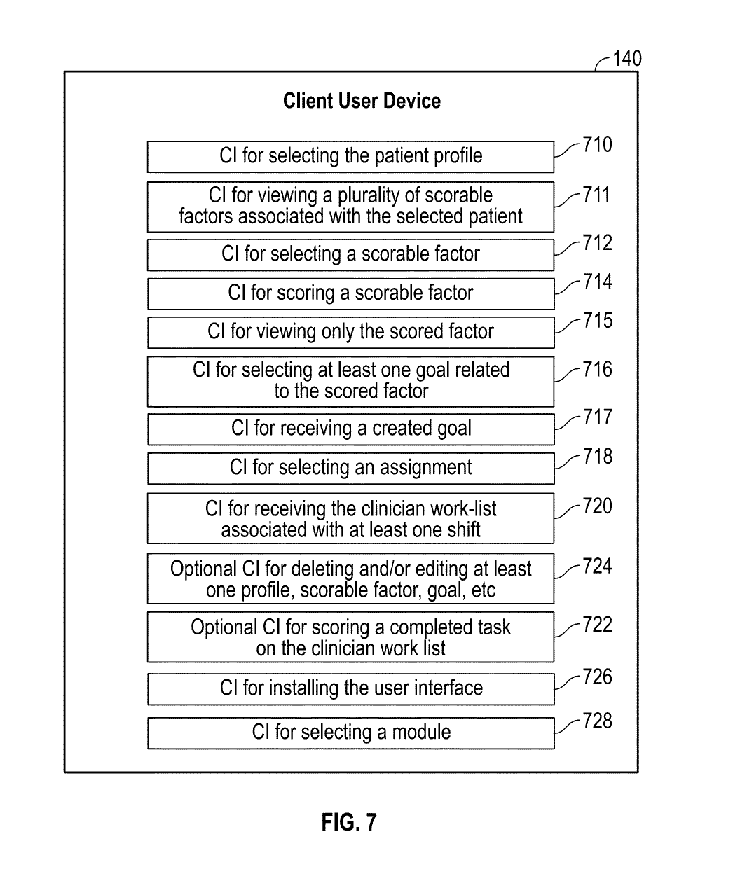

FIG. 7 is an illustration of a non-limiting embodiment of the user client device 140. The user client device 140 may have a plurality of computer instructions, such as but not limited to computer instructions for selecting the patient profile 710; computer instructions for viewing a plurality of scorable factors associated with the selected patient profile 711; computer instructions for selecting a scorable factor 712; computer instructions for scoring the scorable factor 714; computer instructions for viewing only the scored factors 715; computer instructions for selecting at least one goal in relation to the scored factor 716; computer instructions for receiving a created goal 717; computer instructions for selecting an assignment of the goal to at least one clinician shift as a task 718; computer instructions for receiving the clinician work-list associated with at least one clinician shift 720; optional computer instructions for scoring a completed task on the clinician work list 722; optional computer instructions for deleting and/or editing at least one patient profile, at least one scorable factor, at least one goal, at least one task, and combinations thereof 724; computer instructions for installing the user interface 726; computer instructions for selecting a module 728; and combinations thereof.

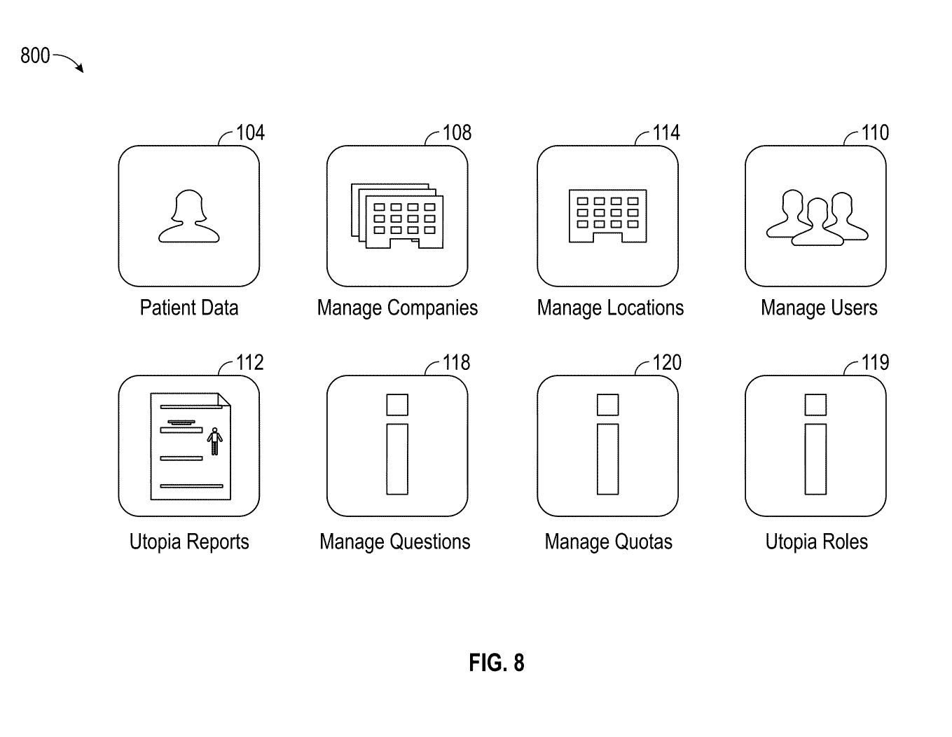

FIG. 8 is a screenshot of a home screen 800 where a user can select a module from a client device, such as but not limited to the work-list module 104, the companies module 108, the manage locations module 114, the users module 110, the reports module 112, the questions module 118, the quoras module 120, the roles module 119, etc.

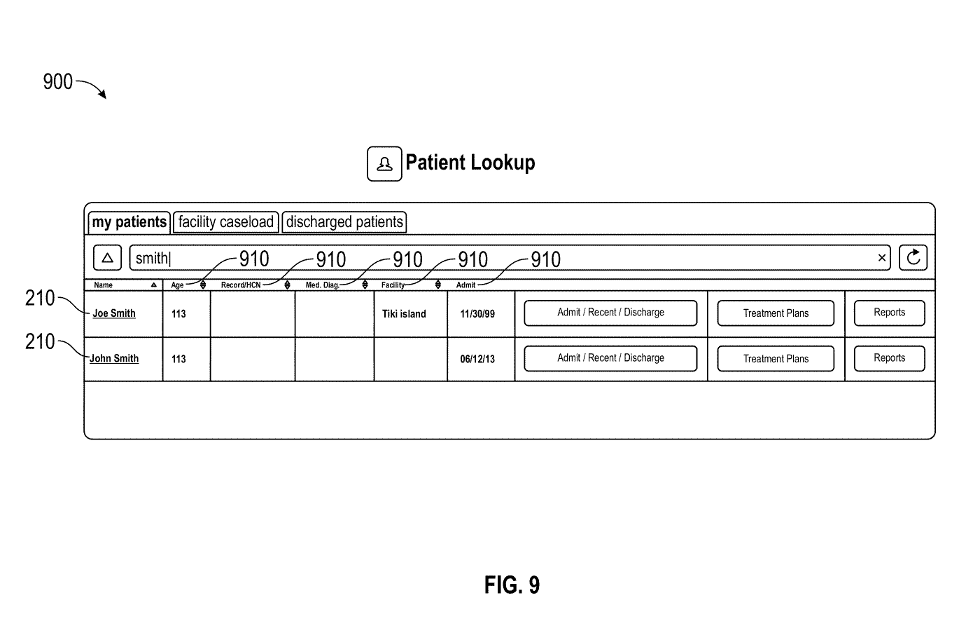

FIG. 9 is a screenshot of the patient selection screen 900. After the user has selected the work-list module (FIG. 8), the user may select at least one patient profile 210. The patient profile 210 may have patient details 910 displayed on the patient selection screen 900, or the patient selection screen 900 may simply list the patient names depending on the preference, rules, laws, etc. governing the user's viewability of the patient details. Various patient details 910 may be shown or described within the patient profile screen 1000.

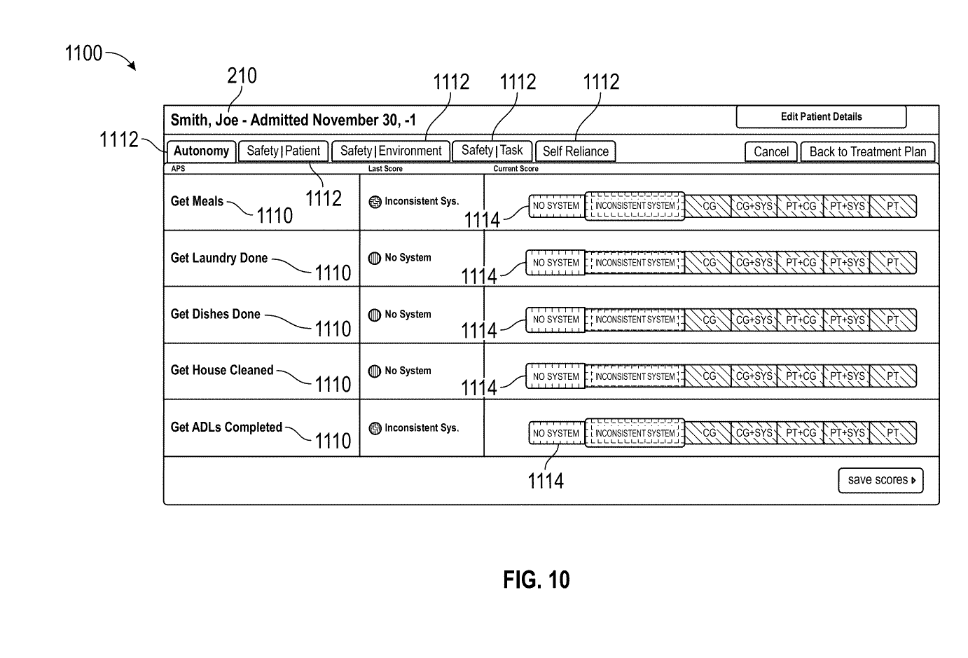

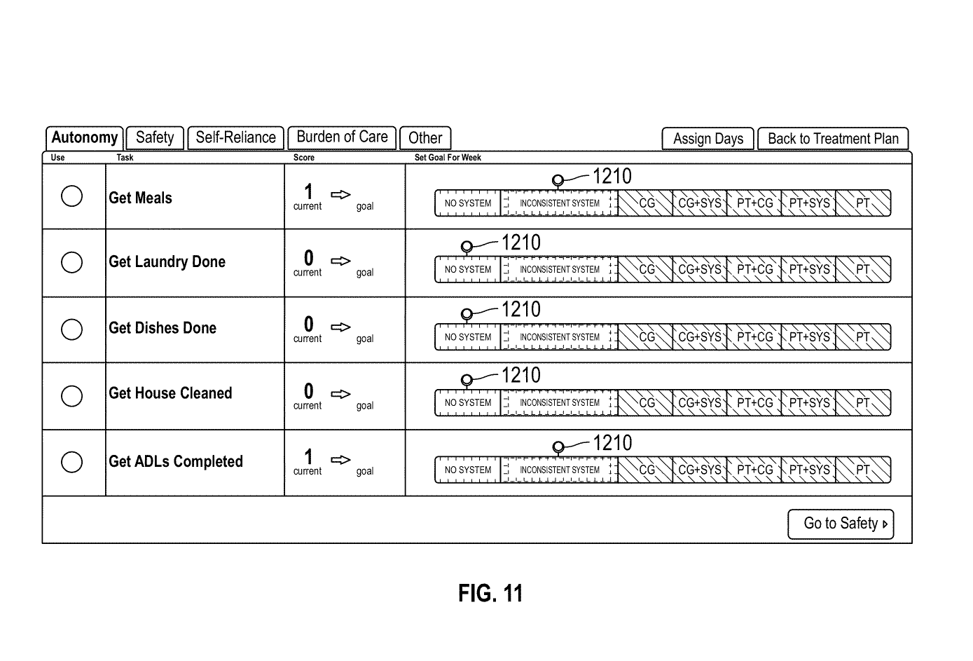

FIG. 10 is a screenshot of a factors screen 1100 where a user may select at least one scorable factor 1110 associated with each patient profile 210. Each factor 1110 may have a scorable ability 1114. Here, each scorable category 1112 is shown at the top of the factors screen 1100 as tabs. Each category 1110 has at least two scorable factors 1110. For example, FIG. 11 depicts the category 1112 of autonomy having five scorable factors 1110 including ‘get meals’, ‘get laundry done’, ‘get dishes done’, ‘get house cleaned’, ‘get ADLs completed’.

In some instances, it may not be necessary for a clinician to score all scorable factors 1110 or score every category 1112 of scorable factors 1110 therein. For example, the patient may have trouble with safety but not autonomy, so the user may select the safety category by clicking the tab at the top of the factors screen 1100 to score only the safety scorable factors and not have to score the autonomy factors.

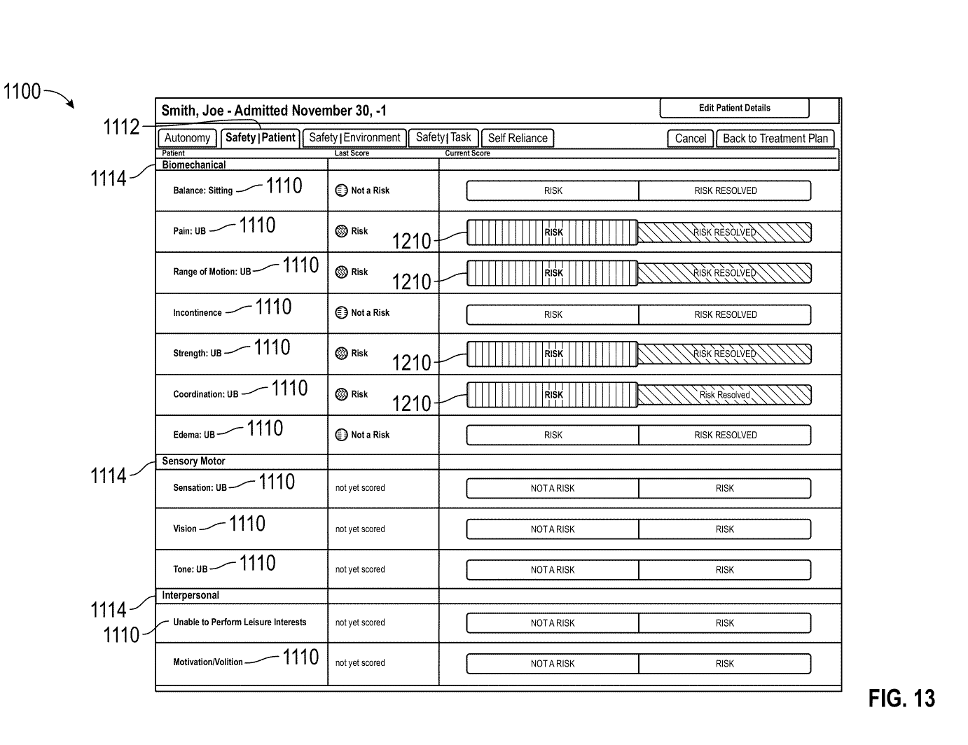

FIG. 11 is a screenshot of the scored factors screen. Only the scored factors 1210 will be available to create goals therefrom. For example, if ‘get meals’ and ‘get house cleaned’ were the only scored factors 1210, goals would only be creatable from these two scored factors. The remaining unscored factors would not be viewable in the goals screen 1300 (FIG. 13).

FIG. 12 is a screenshot of the goals screen 1300 where a goal 1310 may be created in relation to each scored factor 1210. Here, the scored factor 1210 is noted by a circular dot above the scorable factor, and the goal 1310 is noted as a star above the anticipated score of the factor. ‘Scored factor’ is defined herein to mean the ability of the patient at the time of scoring the factor, and ‘goal’ is defined herein to mean the ability the patient may be able to obtain at a later date. As will be shown in FIGS. 13-17, there are various ways to depict and score the scorable factors 1110 and various ways to create goals 1310 from the scored factors 1210. Any method of scoring a scorable factor 1110 and creating a goal 1310 therefrom, which is described herein or otherwise available to one skilled in the art of creating a computer system, may be used.

FIG. 13 is a screenshot of another factors screen 1100. In this non-limiting example, the category 1112 of safety is selected. The scorable factors 1110 may be or include, but are not limited to balance, pain, range of motion, sensation, vision, motivation, etc. There are also subcategories 1114 for the scorable factors 1110 shown, but the subcategories 1114 are not limited to the scorable factors 1110 as depicted; said differently, the scorable factors 1110 may be categorized or subcategorized in many different ways. Here, the scored factors 1210 appear as a ‘risk’ once the scorable factors 1110 have been selected.

FIG. 14 is a screenshot of a different type of goals screen 1300 where the only goal 1310 to select is ‘risk resolved’ in relation to the scorable factors 1110 related to the category 1112 of safety. In another non-limiting instance, the goals for this category 1112 may have a scoring similar to that of ‘autonomy’ where the risk may be ranked on a scale depending on how severe the risk may currently be for the patient, and the goal may be a less severe risk.

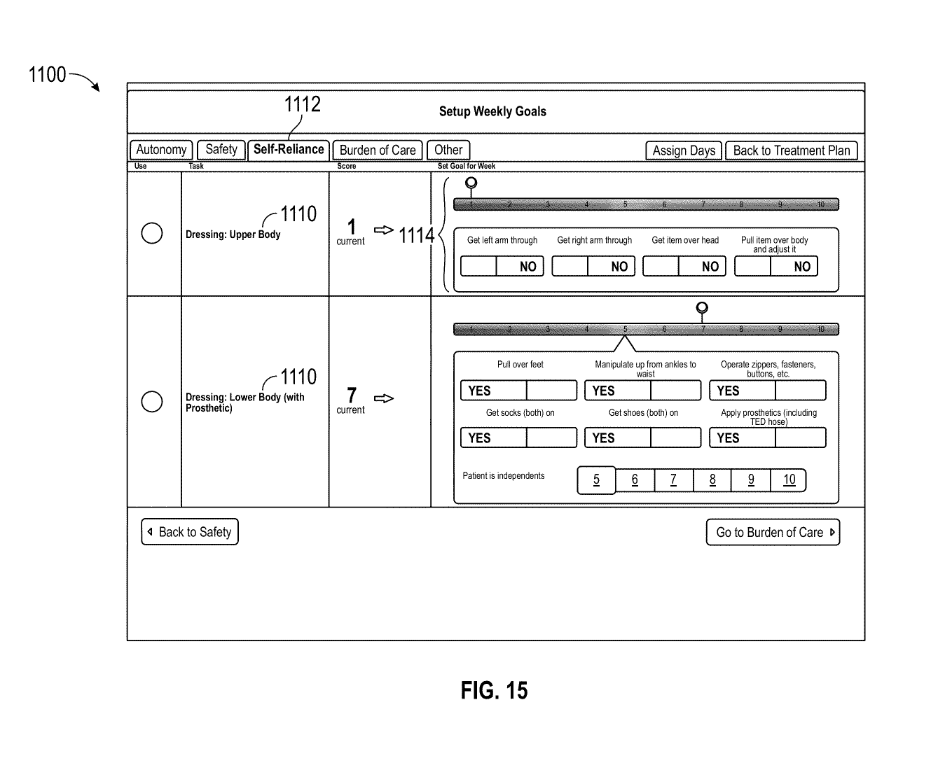

FIG. 15 is a screenshot of a different type of factors screen 1100 where the category 1112 selected is ‘self-reliance’, and the scorable factors 1110 shown are ‘dressing: upper body’ and ‘dressing: lower body’. The scorable factors 1110 related to the patient may be assessed and scored by two mechanisms shown here for assessing the ability 1114. There is a scale of 1-10 shown, but there are also yes/no slidable tabs; both mechanisms may be used to determine a current ability for purposes of creating a goal.

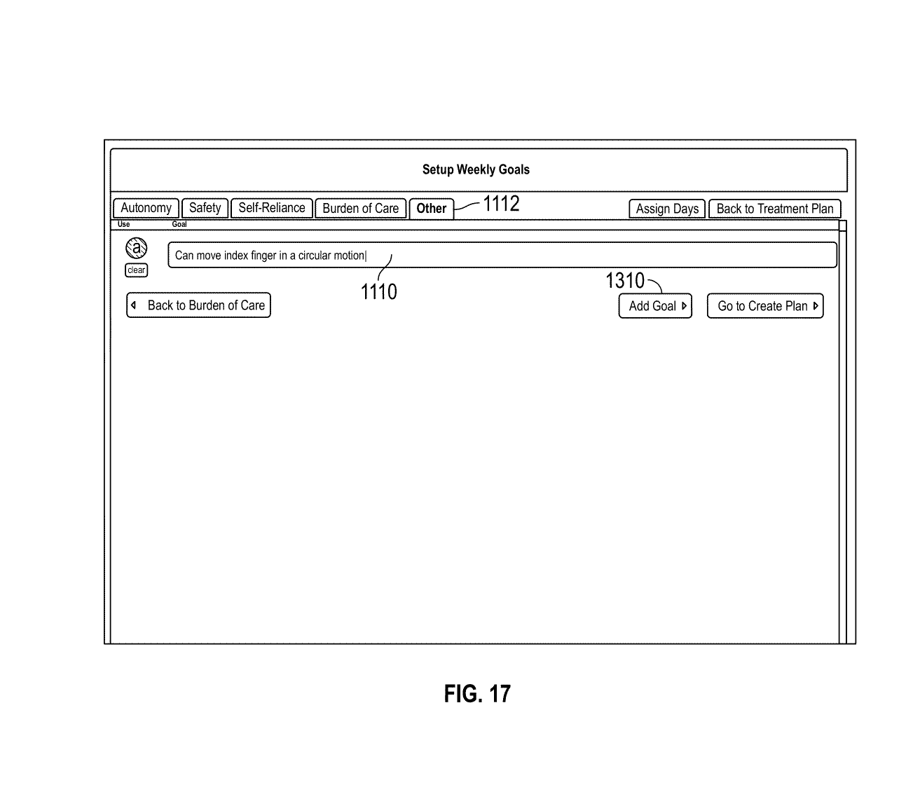

In another non-limiting embodiment, the scorable factor 1110 may be scored by only selecting the scorable factor 1110, as the screenshot in FIG. 17 depicts. The selected scorable factor in this instance is considered a ‘scored factor’ 1210, and a goal 1310 may be created therefrom. In this instance, the goal 1310 would not be scored, but the goal 1310 would merely be to assess each scored factor. In essence, simply selecting a scorable factor 1110 would function as a ‘scored factor’ 1210 and a ‘goal’ 1310 for purposes of the computer-implemented method and system described herein. For example, if the scored factor is ‘optimize environment’, when the environment is optimized, a clinician may select the factor to indicate that the environment was optimized. In an alternative embodiment, an unselected scorable factor may indicate the patient's inability to perform such task, and a goal may be creatable by not selecting the factor.

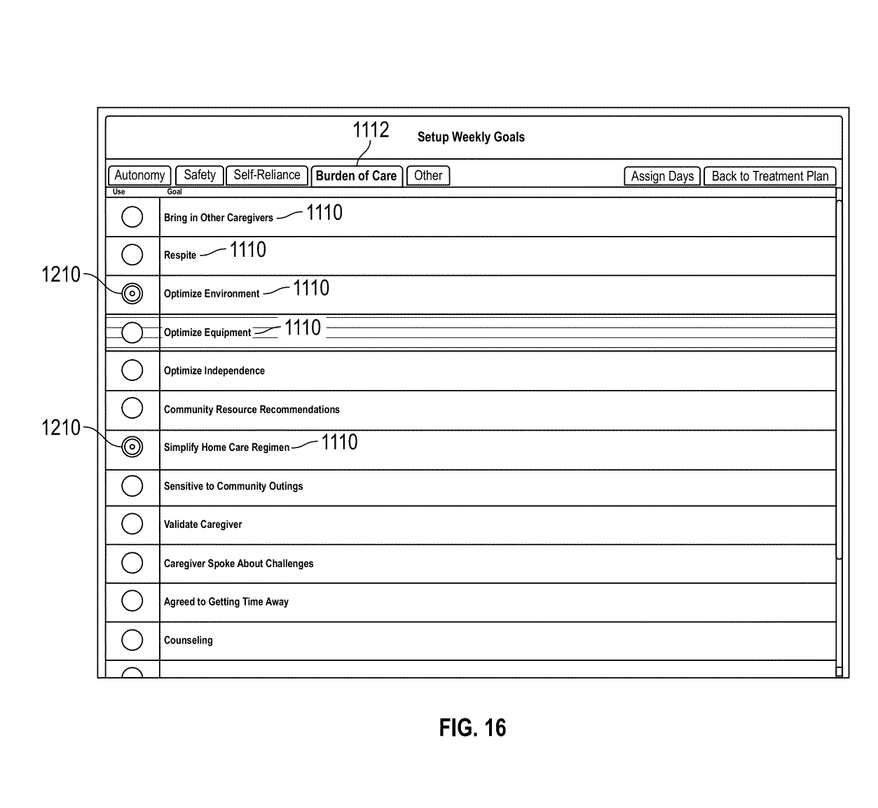

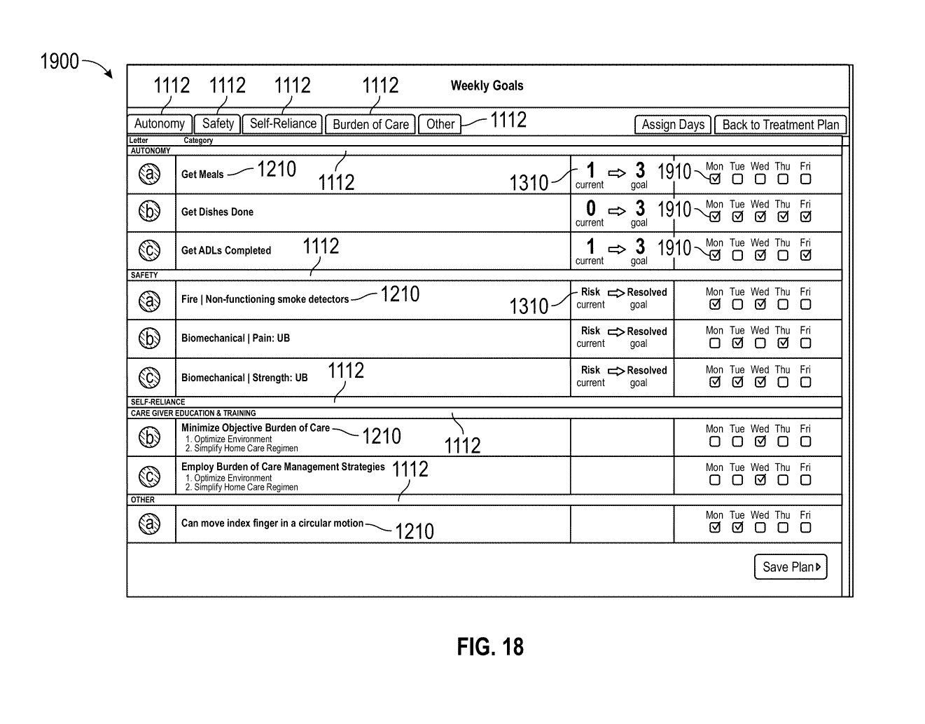

In another non-limiting example, the clinician may need to write in a scorable factor 1110 specific to a patient's needs that would not apply to every patient as the screenshot in FIG. 17 depicts. The clinician may select the category 1112 of ‘other’ and write in the scorable factor 1110. Similar to the example described in FIG. 16, the clinician would create the goal 1310 and assign the ‘other’ task to a clinician shift on a calendar day. The clinician may have a scoring mechanism for such ‘other’ scorable factors 1110, even though such a feature is not exemplified in FIG. 18.

FIG. 18 is another screenshot of an assignment screen 1900. Each category 1112 is shown having each scored factor 1110. Any category 1112 where no scorable factor 1110 was scored (e.g. self-reliance in this example) is minimized to avoid confusion to the clinician. Similarly, any scorable factor 1110 that was not scored is not shown on the assignment screen 1900. By deleting the categories where no factors were scored (e.g. ‘other’ may not be scored) and deleting any unscored factors within the assignment screen, this allows the clinician to focus on what's important to the specific patient. More specifically, the clinician does not create goals by accident, such as mischecking a box for a factor that was not intended to be a goal.

Each scored factor 1210 may be assigned to a clinician shift on a calendar day as a task 1910 for that day. In this non-limiting instance, the task 1910 is shown here as a checkmark for a particular day or days, but other mechanisms of assigning a task 1910 to a clinician work-list may be used. One non-limiting example of this would be to create a work-list of tasks 1910 where each task 1910 is associated with the scored factors 1210, e.g. a to-do list for a given clinician shift. In another non-limiting embodiment, the tasks 1910 are assigned to a specific period of time during a clinician shift.

The goals 1310 may be shown on the assignment screen that relate to each scored factor 1210, but this is not critical to assigning the scored factor 1210 as a task 1910 and the inventors do not wish to be limited to such an embodiment.

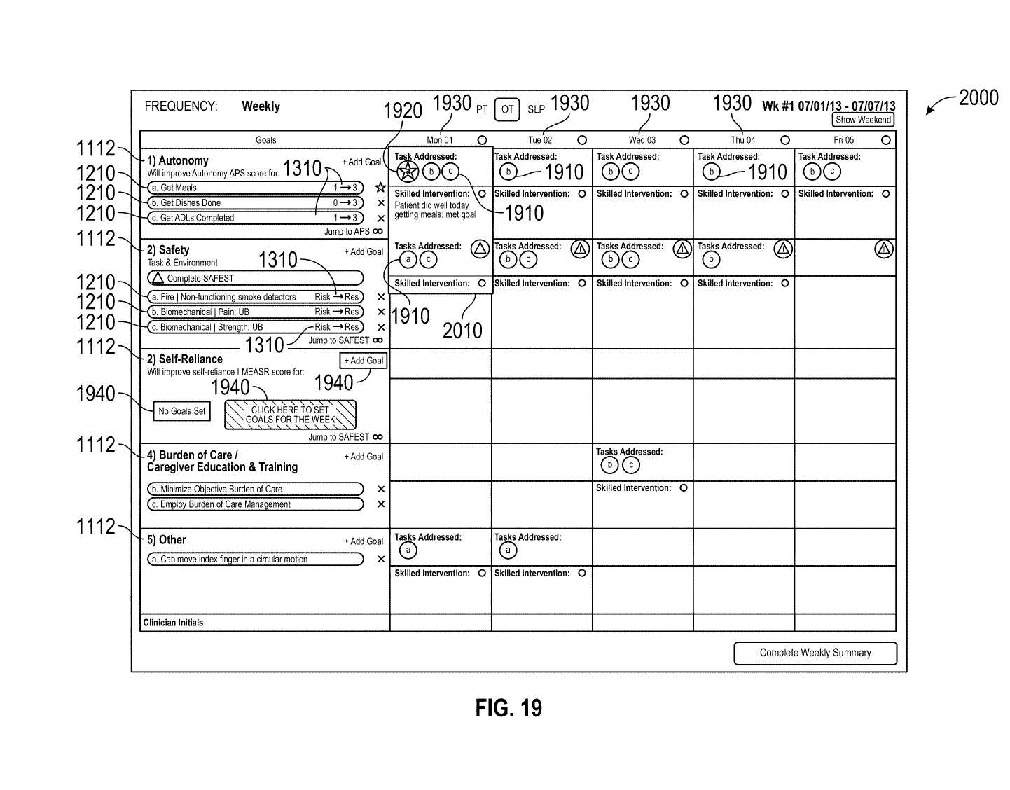

FIG. 19 is a screenshot of a clinician work-list screen 2000 in a non-limiting embodiment. Here, a clinician work-list 2010 has been generated from the tasks assigned to the clinician shifts shown in FIG. 19. Each category 1212 is shown with its list of scored factors 1210 and the goals 1310 associated therewith. The tasks 1910 are assigned to each clinician shift according to the assignment previously made. Once the clinician has completed a task, it may be marked in a way that a clinician would recognize the task as a completed task 1920. In the non-limiting embodiment depicted here, the completed task 1920 is changed from a circle (an uncompleted task 1910) to a star (a completed task 1920).

Also worth noting here, any scorable factor 1110 not previously scored may be accessed from the clinician work-list screen 2000. For example, if only one scorable factor 1110 was scored under the category of autonomy because the initial abilities of the patient only required such an assessment, a follow-up assessment may require scoring of additional scorable factors (or follow-up scorable factors). Here, the self-reliance category does not have any scored factors/goals. To score factors, goals, and assign days for self-reliance related tasks, the user may do so by selecting the category button 1940 for self-reliance, and the user will be taken to the factors screen 1100 (FIG. 10).

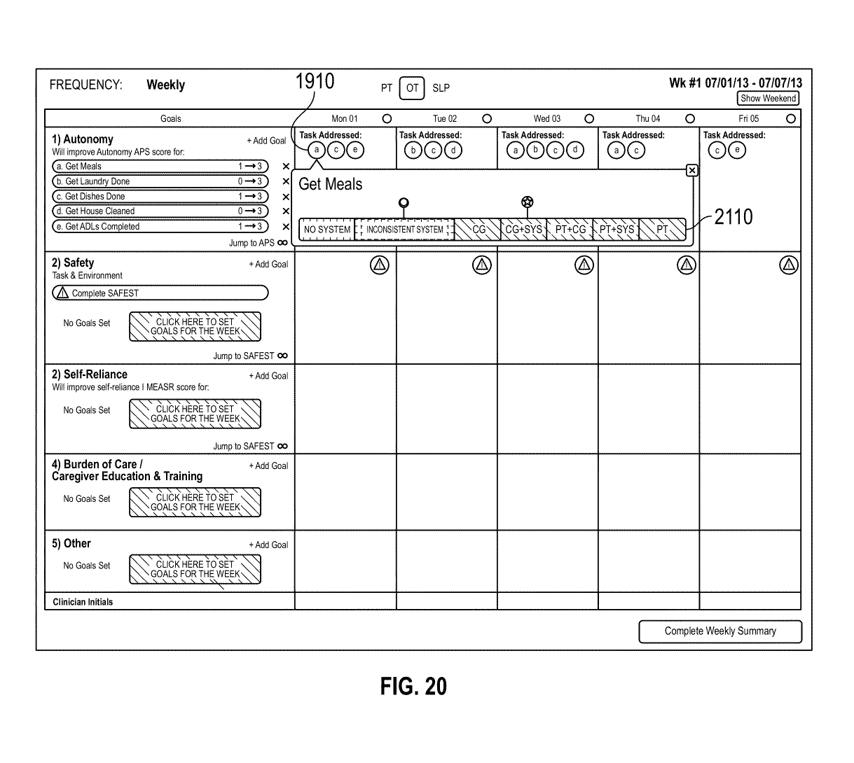

FIG. 20 is a screenshot of non-limiting embodiment of a mechanism to score a task upon completion. The clinician may score the task 1910 in relation to the goal and/or scored factor; the scored task 2110 may then be depicted as a completed task 1920 (FIG. 19). To see the scoring of the completed task, a clinician would simply select the completed task, and the score of the task may open in a new tab or window. In addition, a notes box may be accessed underneath each clinician work-list where the clinician may report any additional notes needed beyond the marking or scoring of a completed task. One non-limiting example of such notes relates to a skilled intervention and the patient's response thereto. For example, the clinician may use knowledge to do an exercise to increase the strength of a quad muscle, and the record of that intervention and the patient response to such intervention may be documented in the skilled intervention box 2210.

In a non-limiting embodiment, a clinician may send at least one note to at least one other clinician within the computer system where the note may be relevant to a patient file. In a non-limiting embodiment, the note may be included within the patient profile, i.e. the patient profile may include a ‘notes’ section. Alternatively, the computer system may include a ‘notes module’ where a clinician may leave a note for another clinician that relates to one or more patient files. A first clinician may input a note into a user client device, and at least a second clinician may view the note from a user client device.

In the foregoing specification, the invention has been described with reference to specific embodiments thereof, and has been described as effective in providing computer-implemented methods and computer systems for generating at least one clinician work-list for treating a patient. However, it will be evident that various modifications and changes can be made thereto without departing from the broader spirit or scope of the invention as set forth in the appended claims. Accordingly, the specification is to be regarded in an illustrative rather than a restrictive sense. For example, specific computer instructions, client devices, scorable factors, goals, reports, and types of users falling within the claimed parameters, but not specifically identified or tried in a particular computer-implemented method or computer system, are expected to be within the scope of this invention.

The present invention may suitably comprise, consist or consist essentially of the elements disclosed and may be practiced in the absence of an element not disclosed. For instance, the computer-implemented method on a non-transitory computer readable medium for generating at least one clinician work-list for treating a patient may consist of or consist essentially of maintaining at least one patient profile for at least one patient, wherein the patient profile comprises patient details and a first scorable factor associated with the at least one patient; selecting the first scorable factor associated with the at least one patient profile from at least one client device; scoring the first scorable factor according to an initial ability of the patient from the at least one client device; creating at least one goal, wherein the created goal has a scoring in relation to the first scored factor; assigning the at least one created goal to at least one clinician shift as at least one task; and generating at least one clinician work-list associated with the at least one clinician shift, wherein the at least one clinician work-list comprises the at least one task.

The computer system may consist of or consist essentially of a host with a processor; a network in communication with the host; at least one client device in communication with the network, wherein the at least one client device comprises at least one user interface, an input device, and a display device; and a data storage in communication with the host. The data storage may have or include at least one patient profile comprising patient details and at least one scorable factor; at least one scorable factor; at least one goal associated to the at least one scorable factor; at least one task assigned to at least one clinician shift where each task is associated with each goal; computer instructions for maintaining each patient profile for each patient; computer instructions for receiving a selection of at least one scorable factor associated with each patient profile from at least one client device; computer instructions for receiving at least one scored factor from the at least one client device; computer instructions for creating at least one goal corresponding to the at least one scored factor; computer instructions for receiving an assignment of created goals to at least one clinician shift as at least one task; and computer instructions for generating at least one clinician work-list associated with the at least one clinician shift, wherein the at least one clinician work-list comprises the at least one task.

The words “comprising” and “comprises” as used throughout the claims, are to be interpreted to mean “including but not limited to” and “includes but not limited to”, respectively.

What is claimed is:

1. A computer implemented method on a non-transitory computer readable medium for generating at least one clinician work-list for treating a patient, the method comprising:
maintaining at least one patient profile for at least one patient, wherein the patient profile comprises at least one patient detail and a first scorable factor associated with the at least one patient;
selecting the first scorable factor associated with the at least one patient profile from at least one client device;
scoring the first scorable factor according to an initial ability of the patient from the at least one client device;
creating at least one goal, wherein the created goal has a scoring in relation to the first scored factor;
assigning the at least one created goal to at least one clinician shift as at least one task;
generating at least one clinician work-list associated with the at least one clinician shift, wherein the at least one clinician work-list comprises the at least one task.

2. The computer implemented method of claim 1, wherein the creating at least one goal occurs from the at least one client device.

3. The computer implemented method of claim 1, wherein the assigning the at least one goal occurs from the at least one client device.

4. The computer implemented method of claim 1, further comprising scoring the at least one task from the at least one client device after generating the at least one clinician work-list.

5. The computer implemented method of claim 4, further comprising generating an alert when the score of the at least one scored task is greater than or equal to the scoring of the at least one created goal.

6. The computer implemented method of claim 1, wherein the first scorable factor is associated with at least one category.

7. The computer implemented method of claim 6, wherein the clinician work-list comprises at least two categories.

8. The computer implemented method of claim 1, further comprising assigning the at least one clinician work-list to a date on a calendar.

9. The computer implemented method of claim 1, further comprising generating at least one report for the at least one patient.

10. The computer implemented method of claim 9, wherein the at least one report comprises the first scored factor, the created goal, the task, or combinations thereof.

11. The computer implemented method of claim 9, wherein the at least one report comprises a status from at least two clinicians.

12. The computer implemented method of claim 1, further comprising receiving at least one patient detail for at least one patient, and creating at least one patient profile with the at least one patient detail prior to maintaining the at least one patient profile.

13. The computer implemented method of claim 1, further comprising:
receiving follow-up information associated with the at least one patient profile, wherein the follow-up information comprises at least one follow-up assessment of the patient;
selecting a follow-up factor from the at least one client device;
scoring at least one follow-up factor according to a follow-up ability of the patient from the at least one client device; and
generating at least one follow-up report, wherein the at least one follow-up report comprises the at least one scored follow-up factor.

14. The computer implemented method of claim 13, further comprising:
creating at least one follow-up goal, wherein the created follow-up goal has a scoring in relation to the at least one scored follow-up factor; and
generating at least one follow-up report comprising the at least one follow-up goal.

15. The computer implemented method of claim 14, further comprising:
assigning the at least one created follow-up goal to at least one clinician shift as at least one follow-up task;
generating at least one clinician follow-up work-list associated with the at least one clinician follow-up shift, wherein the at least one clinician follow-up work-list comprises the at least one follow-up task.

16. A computer system, comprising:
a host with a processor;
a network in communication with the host;
at least one client device in communication with the network, wherein the at least one client device comprises at least one user interface, an input device, and a display device;
a data storage in communication with the host, the data storage comprising:
at least one patient profile comprising at least one patient detail and at least one scorable factor;
at least one scorable factor;
at least one goal associated to the at least one scorable factor;
at least one task assigned to at least one clinician shift where each task is associated with each goal;
computer instructions for maintaining each patient profile for each patient;
computer instructions for receiving a selection of at least one scorable factor associated with each patient profile from at least one client device;
computer instructions for receiving at least one scored factor from the at least one client device;
computer instructions for creating at least one goal corresponding to the at least one scored factor;
computer instructions for receiving an assignment of created goals to at least one clinician shift as at least one task; and
computer instructions for generating at least one clinician work-list associated with the at least one clinician shift, wherein the at least one clinician work-list comprises the at least one task.

17. A computer system, comprising:
a server with a processor;
a network in communication with the server;
at least one client device in communication with the network, wherein the at least one client device comprises at least one user interface, an input device, and a display device;
a data storage in communication with the server, the data storage comprising:
a clinician work-list module; wherein the clinician work-list module comprises:
at least one patient profile;
at least one scorable factor;
at least one goal associated with the at least one scored factor;
at least one task associated with the at least one goal;
at least one clinician shift associated with the at least one task;
computer instructions for maintaining each patient profile for each patient;
computer instructions for receiving a selection of at least one scorable factor associated with each patient profile from at least one client device;
computer instructions for receiving at least one scored factor from the at least one client device;
computer instructions for creating at least one goal corresponding to the at least one scored factor;
computer instructions for receiving an assignment of created goals to at least one clinician shift as at least one task; and
computer instructions for generating at least one clinician work-list associated with the at least one clinician shift, wherein the at least one clinician work-list comprises the at least one task;
a companies module comprising:
at least one company profile;
computer instructions for maintaining at least one company profile, wherein the at least one company profile comprises at least one company detail for the at least one company; and
a users module comprising:
at least one user profile;
at least one user privilege;
at least one user location;
computer instructions for maintaining at least one user profile, wherein each user profile comprises at least one user detail for each user;
computer instructions for receiving a user selection from a client device;
computer instructions for receiving at least one selected user privilege for each user; and
computer instructions for receiving a location assignment for each user.
